(19) United States
(12) Patent Application Publication
(10) Pub. No.: US 2003/0087795 A1
(43) Pub. Date: May 8, 2003

(54) Hard surface cleaning composition

(76) Inventors: William A. Wood, Shawnee, KS (US); John H. Beasley, Olathe, KS (US)

Correspondence Address: STINSON MORRISON HECKER LLP, ATTN: PATENT GROUP, 1201 WALNUT STREET, SUITE 2800, KANSAS CITY, MO, 64106-2150, US

(21) Appl. No.: 10/010,329

(22) Filed: Nov. 2, 2001

(51) Int. Cl. C11D 1/00

(52) U.S. Cl. 510/511; 510/180; 510/238; 510/236

(57) ABSTRACT

A hard surface cleaning composition containing an abrasive agent and a saponifying agent, namely sodium metasilicate, is provided. The composition of the present invention is abrasive enough to adequately break up carbon based stains which are adhered to hard surfaces such as ceramic, glass and the like, but is not as corrosive as prior cleaning compositions for similar applications. The cleaning composition is an improved pour-on, liquid cleaner which may be applied for immediate stain removal when coupled with a rubbing action, or which may be allowed to soak and penetrate stubborn stains over time.

### STATEMENT REGARDING FEDERALLY SPONSORED RESEARCH OR DEVELOPMENT

Not Applicable.

### CROSS-REFERENCE TO RELATED APPLICATIONS

Not Applicable.

### BACKGROUND OF THE INVENTION

This invention relates to cleaning compositions. More specifically, this invention relates to cleaning compositions containing sodium metasilicate, the composition for cleaning hard surfaces such as ceramic and glass.

Cleaning hard surfaces such as ceramic, glass and the like presents unique challenges. Particularly, carbon-based stains, such as those caused by fats and oils, have a tendency to adhere rather strongly to such surfaces, making them difficult to remove. In an attempt to adequately eliminate these carbon-based stains, abrasive hard surface cleaners have been developed. While abrasive cleaners often are effective at breaking up stains, thus enabling their removal, the abrasive particles contained in such cleaners often cause scratching of the surface to be cleaned. This is because in order for the abrasive cleaner to be effective in breaking up stubborn stains, the particle size must be rather large and very hard. Since it obviously is desirable to avoid damaging the surface to be cleaned, abrasive cleaners often are not desirable.

As an alternative, hard surface cleaners have been developed which contain a saponifying agent rather than an abrasive. The saponifying agent makes the oils and fats soluble in water thus permitting their removal without intense rubbing or abrasion. Often, however, such agents are fairly corrosive.

To overcome the deficiencies found with conventional hard surface cleaners, a cleaning composition is needed which is not so abrasive that it causes scratching of the surface to be cleaned, and that is less corrosive than prior cleaning compositions for similar applications.

### SUMMARY OF THE INVENTION

Accordingly, the present invention provides a hard surface cleaning composition that contains an abrasive having a sufficiently large particle size to aid in breaking up carbon-based stains but not so large as to scratch the surface to be cleaned. Additionally, the present invention provides a hard surface cleaning composition that saponifies stubborn stains but is less corrosive than prior cleaning compositions for similar applications.

According to the present invention, the foregoing and other objects are achieved by a composition for cleaning hard surfaces which contains an abrasive agent and a saponifying agent, namely sodium metasilicate. The cleaning composition of the present invention further contains a solvent, a surfactant, and a thickening agent. The abrasive agent contains particles having a large enough median particle diameter to effectively break up carbon-based stains but no so large as to scratch the surface to be cleaned.

Additional aspects of the invention, together with the advantages and novel features appurtenant thereto, will be set forth in part in the description which follows, and in part will become apparent to those skilled in the art upon examination of the following, or may be learned from the practice of the invention. The objects and advantages of the invention may be realized and attained by means, instrumentalities and combinations particularly pointed out in the appended claims.

### DETAILED DESCRIPTION OF THE PREFERRED EMBODIMENT

The present invention is directed to an improved liquid cleaning composition containing both an abrasive and a saponifying agent, namely sodium metasilicate. The composition of the present invention may be used for immediate cleaning by simply pouring the product on a specific stain which a user desires to remove and rubbing the composition over the stain until it is removed. Alternatively, the cleaning composition of the present invention may be used in a soaking application for stains that are more stubborn. In this instance, the composition may be poured on the stain and allowed to remain for a period of time before removing. This allows the sodium metasilicate to slowly penetrate the stain until the fats and oils are substantially saponified and easily can be removed. The particular embodiments described herein are intended in all respects to be illustrative rather than restrictive. Alternative embodiments will become apparent to those skilled in the art to which the present invention pertains without departing from its scope.

The cleaning composition of the present invention contains a mixture of a saponifying agent, an abrasive agent, a thickening agent, a surfactant and a solvent. Sodium metasilicate adequately saponifies fats and oils but is less corrosive than other known cleaning agents. Sodium metasilicate functions in the cleaning composition as a neutralizer, saponifying oils and fats present in the stains to be cleaned thus making the fats and oils soluble in water and permitting easier removal thereof.

In a preferred embodiment, sodium metasilicate comprises between about 1.0% w/w and about 15.0% w/w of the cleaning composition. (All percentages presented herein are weight/weight (w/w) based upon the weight of the final cleaning composition product unless otherwise noted.) More preferably, sodium metasilicate comprises between about 5.0% w/w and 13.0% w/w of the cleaning composition. Most preferably, sodium metasilicate comprises about 10.0% w/w of the cleaning composition of the present invention.

Preferably, sodium metasilicate anhydrous is used in the cleaning composition of the present invention, such as that sold under the brand name Metso 2048, manufactured by PQ Corporation of Valley Forge, Pa. The sodium metasilicate may be anhydrous or hydrated such as sodium metasilicate pentahydrate.

The preferred abrasive agent of the cleaning composition of the present invention is crystalline silica such as that sold under the brand name Imsil 75™, manufactured by Unim Specialty Minerals, Inc. of Elco, Ill., or under the brand names Sil-Co-Sil 106 or Sil-Co-Sil 40, each manufactured by U.S. Silica Company of Berkeley Springs, W. Va. As previously stated, abrasive agents contain particles which may cause scratching of the surface to be cleaned. Accordingly, particular abrasive particle sizes must be selected to reduce surface scratching and yet provide adequate abrasion to break up carbon-based stains. While crystalline silica is the preferred abrasive agent, the appropriate particle sizes will vary dependent upon the brand name of silica selected.

For instance, it is preferred that crystalline silica sold under the brand name Imsil 75™, and manufactured by Unim Specialty Minerals, Inc. of Elco, Ill., be selected for the cleaning composition of the present invention. Accordingly, it is preferred that the crystalline silica have a median particle diameter between about 10.0 and 14.0 microns. More preferably, the crystalline silica has a median particle diameter of between about 11.0 and 13.0 microns. Most preferably, the crystalline silica has a median particle diameter of about 12.0 microns. A median diameter above the indicated preference ranges potentially may scratch the surface to be cleaned and an abrasive particle diameter below the indicated preference ranges potentially may not adequately remove stubborn stains.

In a preferred embodiment of the present invention, crystalline silica comprises between about 5.0% w/w and 40.0% w/w of the cleaning composition. More preferably, crystalline silica comprises between about 18.0% w/w and 35.0% w/w of the cleaning composition. Most preferably, crystalline silica comprises about 30.0% w/w of the cleaning composition of the present invention.

Alternative abrasive agents which can be utilized in the composition of the present invention include, but are not limited to, calcium carbonate and sodium bicarbonate. It will be understood and appreciated by those of skill in the art that if an abrasive component other than crystalline silica is used, the weight percentages of the cleaning composition of the present invention may vary within the stated range. Likewise, if an alternative abrasive agent is utilized, the median particle diameter may vary. All such variations are contemplated to be within the scope of the present invention.

The thickening agent of the present invention aids in maintaining the suspension of the abrasive particles in solution. Accordingly, a thickening agent is an essential component of the cleaning composition of the present invention. The preferred thickening agent is xanthum gum, such as that manufactured by C. P. Kelco, Inc. of Chicago, Ill. In a preferred embodiment, xanthum gum comprises between about 0.3% w/w and 0.5% w/w of the cleaning composition. More preferably, xanthum gum comprises between about 0.35% w/w and 0.45% w/w of the cleaning composition. Most preferably, xanthum gum comprises about 0.40% w/w of the cleaning composition of the present invention.

Alternative thickening agents that may be utilized in the cleaning composition of the present invention include, but are not limited to, guar gum, sodium carboxymethyl cellulose, carbopol ETD2691, manufactured by BF Goodrich Company of Cleveland, Ohio, and alcogum SL-70, manufactured by Alco Chemical of Chattanooga, Tenn. It will be understood and appreciated by those of skill in the art that if a thickening agent other than xanthum gum is utilized, the weight percentages may vary within the stated range. Such variations are intended to be within the scope of the present invention.

To adequately effect the cleaning action of the cleaning composition of the present invention, the composition must contain a surfactant. However, the particular surfactant utilized in the cleaning composition is not critical. In a preferred embodiment of the present invention, poly(oxy-1,2-ethanediyl)-alpha-undecyl-omega, such as that sold under the brand name Tomadol 1-7, manufactured by Tomah Products, Inc. of Reserve, La., is utilized as a surfactant. Preferably, the surfactant comprises between about 0.2% w/w and 5.0% w/w of the cleaning composition. More preferably, the surfactant comprises between about 0.35% w/w and 2.0% w/w of the cleaning composition. Most preferably, surfactant comprises about 0.5% w/w of the cleaning composition of the present invention.

Alternative surfactants that may be utilized in the cleaning composition of the present invention include, but are not limited to poly(oxy-1,2-ethanediyl)-alpha-[(1,3,3-tetramethylbutyl)phenyl]-omega hydro; benzenesulfonic acid, dodecyl-sodium salt; Mercol 60, manufactured by Cap City Products Company, Inc. of Kearny, N.J.; poly (oxy-1,2-ethanediyl), alpha-(nonylphenyl)-omega-hydroxy; polyalkyleneoxide modified polydimethylsiloxane; and fatty acids, coco, reaction products with diethanolamine, for example Ninol 11-CM, manufactured by Stepan Company of Northfield, Ill. It will be understood and appreciated by those of skill in the relevant art that if a surfactant other than poly-(oxy-1,2-ethanediyl)-alpha-undecyl-omega is utilized in the cleaning composition of the present invention, the weight percentages may vary within the stated range. Such variations are intended to be within the scope of the present invention.

The preferred solvent of the present invention is water. Preferably, water comprises between about 40.0% w/w and 95.0% w/w of the cleaning composition. More preferably, water comprises between about 50.0% w/w and 80.0% w/w of the cleaning composition. Most preferably, water comprises about 59% w/w of the cleaning composition of the present invention.

Alternative solvents which may be utilized in the cleaning composition of the present invention include, but are not limited to, mineral spirits, citrus terpene, ethylene glycol n-butyl ether, and diethylene glycol n-butyl ether. It will be understood and appreciated by those of skill in the art that if a solvent other than water is utilized, weight percentages may vary within the stated range. Such variations are contemplated to be within the scope of the present invention.

Optionally, to mitigate the odor emitted by many of the above components, the cleaning composition according to the present invention may contain a fragrance. In the preferred embodiment, the fragrance utilized is Fragrance Number 20140, manufactured by Chemia Corporation of Kirkwood, Mo. It is preferred that fragrance comprises between about 0.01% w/w and 0.2% w/w of the cleaning composition. More preferably, fragrance comprises between about 0.015% w/w and 0.05% w/w of the cleaning composition. Most preferably, fragrance comprises about 0.018% w/w of the cleaning composition of the present invention.

The preferred composition prepared according to the present invention comprises 10.0% w/w sodium metasilicate anhydrous (Metso 2048), 30.0% w/w crystalline silica (Imsil 75™), 0.40% w/w xanthum gum, 0.50% w/w poly-(oxy-1,2-ethanediyl)-alpha-undecyl-omega (Tomadol 1-7), 59.082% w/w water and 0.018% w/w fragrance (Chemia #20140). A composition having components in the preferred concentrations is abrasive enough to break up carbon-based stains without scratching the surface to be cleaned and is less corrosive than prior cleaning compositions for similar applications. The composition is a liquid which either may be poured on and allowed to penetrate the stain over time, or may be applied for immediate use when coupled with a rubbing action.

The cleaning composition of the present invention may be prepared by combining the above components together in the appropriate concentrations by any conventional means generally used to evenly distribute abrasive materials in solution. For example, to make a composition of 1000 kg final composition weight according to the present invention, 59.082% w/w water is first added to a container. Next, 30.0% w/w crystalline silica is added and stirring is commenced. Next, while stirring is continued, 0.40% w/w xanthum gum is added, followed by 10.0% w/w sodium metasilicate anhydrous and 0.018% w/w fragrance. With continued stirring, 0.50% w/w poly-(oxy-1,2-ethanediyl)-alpha-undecyl-omega surfactant is added. It will be understood and appreciated that the order in which each of the components is added is not critical and is not intended as a limitation of the present invention, although it is preferable to start with about 30%-60% w/w water, and is most preferable to start with about 50% w/w water.

The following are examples of methods which could be utilized to make a hard surface cleaning composition according to the present invention. The following examples are merely exemplary and are not presented by way of limitation.

### EXAMPLE 1

Initially, 57.68% w/w water is added to a container and agitation begins. Subsequently, 30.0% w/w crystalline silica is added to the water. With continued agitation, 0.3% w/w xanthum gum is added, followed by 10.0% w/w sodium metasilicate anhydrous and 0.02% w/w fragrance. Lastly, 2.0% w/w poly-(oxy-1,2-ethanediyl)-alpha-undecyl-omega surfactant is added to the container and the mixture is stirred.

### EXAMPLE 2

Initially, 59.95% w/w water is added to a container and stirring begins. Subsequently, 27.0% w/w crystalline silica is added to the water. With continued agitation, 0.4% w/w xanthum gum is added, followed by 12.0% w/w sodium metasilicate anhydrous and 0.02% w/w fragrance. Lastly, 0.6% w/w poly-(oxy-1,2-ethanediyl)-alpha-undecyl-omega surfactant is added to the container and the mixture is stirred.

### EXAMPLE 3

Initially, 59.09% w/w water is added to a container and agitation begins. Subsequently, 25.0% w/w crystalline silica is added to the water. With continued agitation, 0.4% w/w xanthum gum is added, followed by 15.0% w/w sodium metasilicate anhydrous and 0.01% w/w fragrance. Lastly, 0.5% w/w poly-oxy-1,2-ethanediyl, alpha-(nonylphenyl)-omega-hydroxy surfactant is added to the container and the mixture is agitated.

### EXAMPLE 4

Initially, 68.9% w/w water is added to a container and agitation begins. Subsequently, 20.0% w/w crystalline silica is added to the water. With continued agitation, 0.4% w/w guar gum is added, followed by 10.0% w/w sodium metasilicate anhydrous and 0.2% w/w fragrance. Lastly, 0.5% w/w poly-oxy-1,2-ethanediyl, alpha-(nonylphenyl)-omega-hydroxy surfactant is added to the container and the mixture is agitated.

As previously described, this invention provides a hard surface cleaning composition that is abrasive enough to break up carbon-based stains without scratching the surface to be cleaned. Further, the present invention provides a cleaning composition containing a saponifying agent which is not as corrosive as prior cleaning compositions for similar applications. The composition is a liquid which either may be poured on and allowed to penetrate the stain over time or may be applied for immediate use when coupled with a rubbing action.

In summary, the present invention is directed to a liquid, abrasive, hard surface cleaning composition containing an abrasive agent and a saponifying agent, namely sodium metasilicate. The present invention has been described in relation to particular embodiments which are intended in all respects to be illustrative rather than restrictive. Alternative embodiments will become apparent to those skilled in the art to which the present invention pertains without departing from its scope.

From the foregoing, it will be seen that this invention is one well adapted to attain all the ends and objects hereinabove set forth together with other advantages which are obvious and which are inherent to the composition.

It will be understood that certain features and subcombinations are of utility and may be employed without reference to other features and subcombinations. This is contemplated by and is within the scope of the claims.

Having thus described the invention, what is claimed is:

1. A cleaning composition comprising:
sodium metasilicate;
an abrasive agent;
a thickening agent;
a surfactant soluble in water and compatible with sodium metasilicate; and
water.

2. The cleaning composition as recited in claim 1, wherein said abrasive agent comprises one or more of crystalline silica, calcium carbonate, and sodium bicarbonate.

3. The cleaning composition as recited in claim 2, wherein said abrasive agent is crystalline silica.

4. The cleaning composition as recited in claim 1, wherein said thickening agent comprises one or more of xanthum gum, guar gum, and sodium carboxymethyl cellulose.

5. The cleaning composition as recited in claim 4, wherein said thickening agent is xanthum gum.

6. The cleaning composition as recited in claim 1, wherein the cleaning composition comprises about 1.0%-15.0% w/w sodium metasilicate, about 5.0%-40.0% w/w abrasive agent, about 0.3%-0.5% w/w thickening agent, about 0.2%-5.0% w/w surfactant, and about 40.0%-95.0% w/w water.

7. The cleaning composition as recited in claim 1, wherein the cleaning composition comprises about 5.0%-13.0% w/w sodium metasilicate, about 18.0%-35.0% w/w abrasive agent, about 0.35%-0.45% w/w thickening agent, about 0.35%-2.0% w/w surfactant, and about 50.0%-80.0% w/w water.

8. The cleaning composition as recited in claim 1, wherein the cleaning composition comprises about 10.0% w/w sodium metasilicate, about 30.0% w/w abrasive agent, about 0.40% w/w thickening agent, about 0.5% w/w surfactant, and about 59.1% w/w water.

9. The cleaning composition as recited in claim 1, further comprising a fragrance.

10. The cleaning composition as recited in claim 3, wherein said abrasive agent contains particles having a median particle diameter between about 10.0 and 14.0 microns.

11. The cleaning composition as recited in claim 3, wherein said abrasive agent contains particles having a median particle diameter between about 11.0 and 13.0 microns.

12. The cleaning composition as recited in claim 3, wherein said abrasive agent contains particles having a median particle diameter of about 12.0 microns.

13. A cleaning composition comprising:
sodium metasilicate;
crystalline silica;
a thickening agent;
a surfactant soluble in water and compatible with sodium metasilicate; and
water.

14. A cleaning composition comprising:
sodium metasilicate;
crystalline silica;
xanthum gum;
poly-(oxy-1,2-ethanediyl)-alpha-undecyl-omega; and
water.

15. A cleaning composition as recited in claim 14, wherein the cleaning composition comprises about 1.0%-5.0% w/w sodium metasilicate, about 5.0%-40.0% w/w crystalline silica; about 0.3%-0.5% w/w xanthum gum, about 0.2%-5.0% w/w poly-(oxy-1,2ethanediyl)-alpha-undecyl-omega; and about 40.0%-95.0% w/w water.

16. A cleaning composition as recited in claim 14, wherein the cleaning composition comprises about 5.0%-13.0% w/w sodium metasilicate, about 18.0%-35.0% w/w crystalline silica; about 0.35%-0.45% w/w xanthum gum, about 0.35%-2.0% w/w poly-(oxy-1,2ethanediyl)-alpha-undecyl-omega; and about 50.0%-80.0% w/w water.

17. A cleaning composition as recited in claim 14, wherein the cleaning composition comprises about 10.0% w/w sodium metasilicate, about 30.0% w/w crystalline silica; about 0.4% w/w xanthum gum, about 0.5% w/w poly-(oxy-1,2-ethanediyl)-alpha-undecyl-omega; and about 59.1% w/w water.

18. A cleaning composition as recited in claim 14, wherein said crystalline silica contains particles having a median particle diameter between about 10.0 and 14.0 microns.

19. A cleaning composition as recited in claim 14, wherein said crystalline silica contains particles having a median particle diameter between about 11.0 and 13.0 microns.

20. A cleaning composition as recited in claim 14, wherein said crystalline silica contains particles having a particle diameter of about 12.0 microns.
